(19) United States
(12) Patent Application Publication
(10) Pub. No.: US 2020/0029009 A1
(43) Pub. Date: Jan. 23, 2020

(54) SYSTEM, IMAGE CAPTURING APPARATUS, COMMUNICATION TERMINAL, AND COMPUTER-READABLE STORAGE MEDIUM

(71) Applicant: HONDA MOTOR CO.,LTD., Tokyo (JP)

(72) Inventor: Masaru OTAKA, Saitama (JP)

(21) Appl. No.: 16/512,396

(22) Filed: Jul. 16, 2019

(30) Foreign Application Priority Data
Jul. 17, 2018 (JP) 2018-134071

(51) Int. Cl. H04N 5/232; H04N 7/18; H04N 5/225; H04N 7/04

(52) U.S. Cl. CPC H04N 5/23206; H04N 7/04; H04N 5/2253; H04N 7/183

(57) ABSTRACT

A system is provided, the system including: a management server that manages an image; and an image capturing apparatus, wherein the image capturing apparatus has: an image capturing unit; a request receiving unit that receives an image-capturing request to capture an image of an image-captured subject from a communication terminal owned by the image-captured subject, the image-capturing request including identification information about a captured-image viewer; a captured-image acquiring unit that, upon reception of the image-capturing request, acquires a captured image captured by the image capturing unit; and a first image transmitting unit that transmits the captured image and the identification information about the captured-image viewer to the management server, and the management server has a second image transmitting unit that transmits, to a communication terminal of the captured-image viewer, the captured image received from the image capturing apparatus.

The contents of the following Japanese patent application are incorporated herein by reference: 2018-134071 filed in JP on Jul. 17, 2018

### BACKGROUND

### 1. Technical Field

The present invention relates to a system, an image capturing apparatus, a communication terminal, and a computer-readable storage medium.

### 2. Related Art

There are known systems that provide captured images collected from vehicles at various geographical locations via networks (see Patent Literature 1, for example).

### PRIOR ART LITERATURE

### Patent Literature

[Patent Literature 1] Japanese Patent Application Publication No. 2015-186123

### SUMMARY

It is desired to provide a technique that can encourage transmission of captured images by reducing the burden on vehicle owners in transmitting the captured images.

### BRIEF DESCRIPTION OF THE DRAWINGS

FIG. 1 schematically illustrates an exemplary system 10.

FIG. 2 schematically illustrates an exemplary flow of process to be performed at the system 10.

FIG. 3 schematically illustrates an exemplary functional configuration of a management server 100.

FIG. 4 schematically illustrates an exemplary functional configuration of a communication terminal 400.

FIG. 5 schematically illustrates an exemplary configuration of a vehicle 200.

FIG. 6 schematically illustrates an exemplary functional configuration of a control device 500.

FIG. 7 schematically illustrates an exemplary hardware configuration of a computer 1000 to function as the management server 100 or control device 500.

FIG. 8 schematically illustrates an exemplary hardware configuration of a computer 1100 to function as the communication terminal 400.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

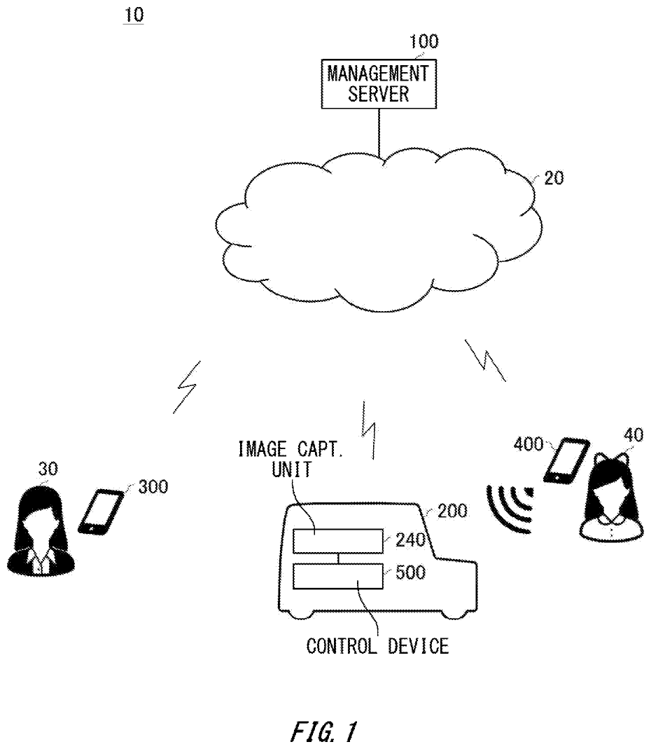

FIG. 1 schematically illustrates an exemplary system 10. The system 10 includes a management server 100, and a control device 500. As illustrated in FIG. 1, the control device 500, for example, is arranged in a vehicle 200, and controls the vehicle 200.

The management server 100 manages captured images. For example, the management server 100 receives, from the vehicle 200, a captured image captured by an image capturing unit 240 of the vehicle 200, and stores the captured image. Then, the management server 100 transmits a stored captured image in response to a request or the like.

The management server 100 according to the present embodiment provides a captured image of an image-captured subject which is an image-captured target, in response to a request from a captured-image viewer who is to view the captured image. The relationship between the image-captured subject and the captured-image viewer may be any relationship. For example, the captured-image viewer is a watcher, and the image-captured subject is a watched person. Here, a watcher 30 and a watched person 40 are illustrated as the captured-image viewer and the image-captured subject.

The management server 100 provides, to the watcher 30, a captured image of the watched person 40 in response to a request from the watcher 30. For example, the management server 100 receives a request from a communication terminal 300 of the watcher 30, requests the vehicle 200 to capture an image of the watched person 40 via a communication terminal 400 of the watched person 40, receives a captured image of the watched person 40 from the vehicle 200, and transmits the captured image to the communication terminal 300.

Communication between the management server 100, the vehicle 200, the communication terminal 300, and the communication terminal 400 may be performed via a network 20. The network 20 includes a mobile phone network such as a so-called 3G (3rd Generation) network, LTE (Long Term Evolution) network, 4G (4th Generation) network or 5G (5th Generation) network. The network 20 may further include the internet, a public wireless LAN (Local Area Network), a leased network, or the like. Data communication via the network 20 incurs a communication cost corresponding to a communication amount.

The management server 100 may store watch-over registration information in which the watcher 30 and the watched person 40 are associated with each other. The watch-over registration information may include user identification information identifying the watcher 30, terminal identification information identifying the communication terminal 300 of the watcher 30, user identification information identifying the watched person 40, and terminal identification information identifying the communication terminal 400 of the watched person 40.

The user identification information about the watcher 30 may be any information as long as it allows identification of the watcher 30 registered for a service, and for example is an ID allocated to the watcher 30. The same applied to the user identification information about the watched person 40. The terminal identification information may be any information as long as it allows identification of the communication terminals, and for example may be at least any one of an IMSI (International Mobile Subscriber Identity), an IMEI (International Mobile Equipment Identity), and a phone number.

A plurality of watched persons 40 may be associated with one watcher 30. In addition, a plurality of watchers 30 may be associated with one watched person 40. For example, the watch-over registration information is registered by the watcher 30 using the communication terminal 300 or the like.

The relationship between the watcher 30 and the watched person 40 may be any relationship. For example, in exemplary relationships between the watcher 30 and the watched person 40: the watched person 40 is a child, and the watcher 30 is his/her parent; the watched person 40 is an elderly person, and the watcher 30 is a family member; and so on. FIG. 1 illustrates an example where the watched person 40 is a child, and the watcher 30 is his/her parent.

For example, the management server 100 first communicates with the communication terminal 300 of the watcher 30, and receives configuration information instructing the management server 100 to transmit captured images of the watched person 40 regularly to the communication terminal 300. Next, the management server 100 transmits an instruction to the communication terminal 400 according to the configuration information. For example, the management server 100 transmits, to the communication terminal 400, an instruction to image capturing apparatuses around the communication terminal 400 to capture images of the watched person 40, and to transmit the images to the management server 100.

In response to the instruction, the communication terminal 400 transmits, to surrounding image capturing apparatuses, an image-capturing request to capture images of the watched person 40, and transmit the captured images to the management server 100. The image-capturing request includes identification information about the watcher 30. The identification information about the watcher 30 may be the user identification information about the watcher 30, or may be the terminal identification information about the communication terminal 300 of the watcher 30. The image-capturing request may include identification information identifying the management server 100.

The communication terminal 400 may transmit the image-capturing request to the surrounding image capturing apparatuses via short-range wireless communication. Examples of short-range wireless communication include ones using WiFi (registered trademark) (Wireless Fidelity), Bluetooth (registered trademark), Zigbee (registered trademark), Z-Wave (registered trademark), and the like. In the example illustrated in FIG. 1, the vehicle 200 receives the image-capturing request.

In response to the image-capturing request, the control device 500 of the vehicle 200 transmits, to the management server 100, a captured image captured by the image capturing unit 240, and the identification information about the watcher 30 included in the image-capturing request. The management server 100 transmits the received captured image to the communication terminal 300.

Then, based on the received identification information about the watcher 30, the management server 100 updates charging information about a communication cost incurred from transmission of the captured image from the vehicle 200 to the management server 100. If the management server 100 itself performs a charging process for a communication cost, the management server 100 uses the updated charging information to charge the watcher 30 the communication cost incurred from transmission of the captured image from the vehicle 200 to the management server 100. If charging of a communication cost is performed by a charging server which is different from the management server 100, the management server 100 transmits the charging information to the charging server.

Since the processes mentioned above make it possible to charge not an owner of the vehicle 200, but the watcher 30 a communication cost incurred from transmission of a captured image of the watched person 40 from the vehicle 200 to the management server 100, it is possible to reduce the burden on the owner of an image capturing apparatus in transmitting captured images, and thus to encourage transmission of captured images.

The vehicle 200 may be an exemplary image capturing apparatus. In addition, the control device 500 may be an exemplary image capturing apparatus. Note that examples of image capturing apparatuses are not limited to the vehicle 200 and the control device 500, but include monitor cameras, live cameras, and the like that are installed at various geographical locations.

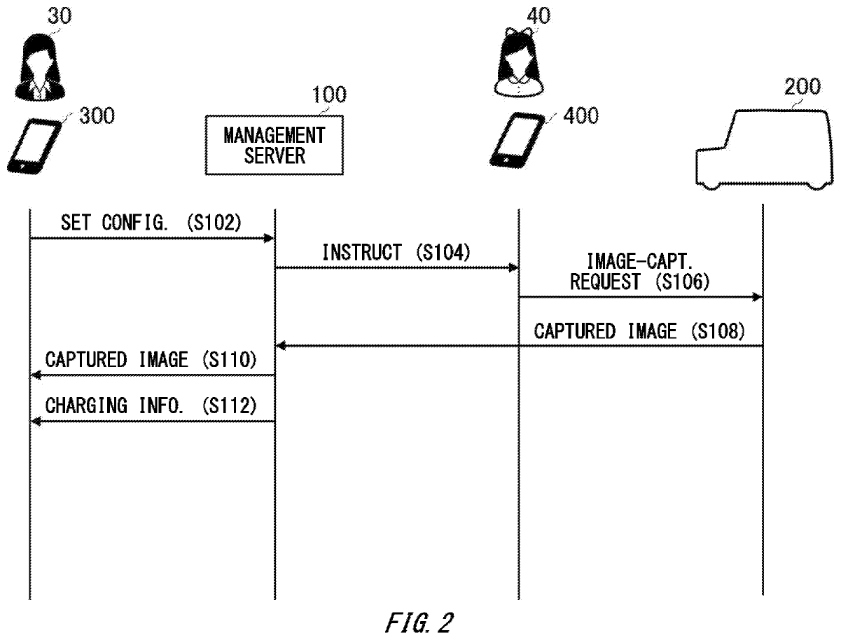

FIG. 2 schematically illustrates an exemplary flow of process to be performed at the system 10. At Step (steps are abbreviated to S's in some cases) 102, the watcher 30 uses the communication terminal 300, and sets the configuration of the management server 100 such that captured images of the watched person 40 are transmitted to the communication terminal 300. The management server 100 may identify the watched person 40 to be a target by referring to configuration contents and watch-over registration information.

The watcher 30 may register, in the management server 100, information about the watched person 40 to be an image-captured target. For example, the watcher 30 registers, in the management server 100, an image of the watched person 40. In addition, the watcher 30 may register, information about the gender, age, appearance, clothes, or the like of the watched person 40. These types of information may be registered in the watch-over registration information.

At S104, the management server 100 transmits an instruction to the communication terminal 400. The management server 100 may transmit, as information included in the instruction, information included in the watch-over registration information.

At S106, the communication terminal 400 transmits an image-capturing request including the identification information about the watcher 30 by using short-range wireless communication. If the received instruction includes information included in the watch-over registration information, the communication terminal 400 may put the information in the image-capturing request. In addition, the communication terminal 400 may store, in advance, an image of the watched person 40, and information about his/her gender, age, appearance, clothes, or the like, and may put them in the image-capturing request.

The control device 500 of the vehicle 200 having received the image-capturing request acquires a captured image of the watched person 40. For example, if the image capturing unit 240 is capturing images continuously, the control device 500 acquires a captured image obtained after the image-capturing request is received. In addition, if the image capturing unit 240 is not capturing images, the control device 500 may instruct the image capturing unit 240 to start image-capturing, and acquire a captured image captured after the start of image-capturing.

If the vehicle 200 includes a plurality of image capturing units 240, the control device 500 may acquire a captured image captured by an image capturing unit 240 capturing images in the direction of arrival of the image-capturing request. In addition, if the image-capturing direction of an image capturing unit 240 can be adjusted, the control device 500 may adjust the image-capturing direction of the image capturing unit 240 such that it matches the direction of arrival of the image-capturing request.

At S108, the control device 500 transmits a captured image and the identification information about the watcher 30 to the management server 100. At S110, the management server 100 transmits the captured image received at S108 to the communication terminal 300. In addition, the management server 100 may update charging information about the watcher 30 based on the identification information about the watcher 30 received at S108. At S112, the management server 100 transmits the updated charging information to the communication terminal 300.

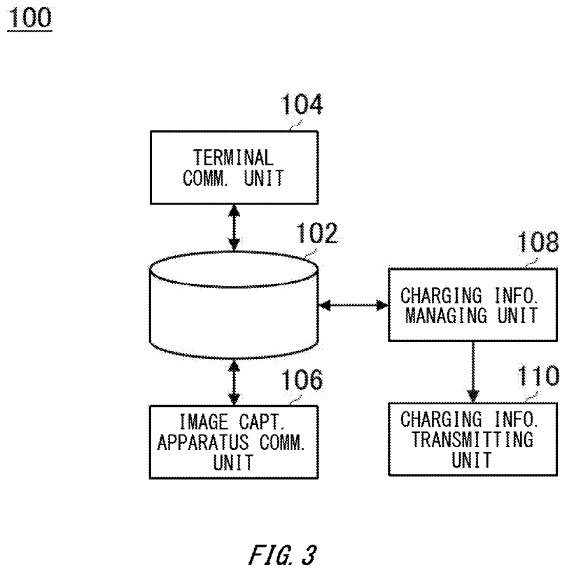

FIG. 3 schematically illustrates an exemplary functional configuration of the management server 100. The management server 100 includes a storage unit 102, a terminal communication unit 104, an image capturing apparatus communication unit 106, a charging information managing unit 108, and a charging information transmitting unit 110. Note that the management server 100 is not necessarily required to include all of these configurations. For example, the management server 100 may not include the charging information managing unit 108, and the charging information transmitting unit 110.

The storage unit 102 stores various types of information. The storage unit 102 stores watch-over registration information. In addition, the storage unit 102 stores charging information about a communication cost to be charged to the watcher 30.

The terminal communication unit 104 communicates with the communication terminal 300, and the communication terminal 400. The terminal communication unit 104 may communicate with the communication terminal 300, and perform registration, updating, and the like of the watch-over registration information. In addition, the terminal communication unit 104 may communicate with the communication terminal 300, and receive configuration information instructing the management server 100 to transmit a captured image of the watched person 40 to the communication terminal 300.

The terminal communication unit 104 may transmit, to the communication terminal 400, an instruction according to the configuration information. For example, the terminal communication unit 104 transmits, to the communication terminal 400, an instruction to image capturing apparatuses around the communication terminal 400 to transmit captured images to the management server 100. The terminal communication unit 104 may transmit, to the communication terminal 400, an instruction to image capturing apparatuses around the communication terminal 400 to transmit captured images of the watched person 40 to the management server 100. The terminal communication unit 104 may transmit, as information included in the instruction, information included in the watch-over registration information stored in the storage unit 102.

The image capturing apparatus communication unit 106 communicates with an image capturing apparatus. For example, the image capturing apparatus communication unit 106 communicates with the vehicle 200. The image capturing apparatus communication unit 106 may communicate with the control device 500 of the vehicle 200. For example, the image capturing apparatus communication unit 106 receives a captured image of the watched person 40 from the control device 500, and the identification information about the watcher 30. The image capturing apparatus communication unit 106 may store, in the storage unit 102, the received captured image, and the identification information about the watcher 30 in association with each other. The terminal communication unit 104 may transmit, to the communication terminal 300, a captured image stored in the storage unit 102. The terminal communication unit 104 may be an exemplary second image transmitting unit.

Based on the identification information about the watcher 30 corresponding to a captured image transmitted by the terminal communication unit 104 to the communication terminal 300, the charging information managing unit 108 updates charging information about the watcher 30 such that the charging information reflects a communication cost incurred from transmission of the captured image from the vehicle 200 to the management server 100. The charging information managing unit 108 may execute a process of charging the watcher 30 according to the updated charging information.

The charging information transmitting unit 110 may transmit, to the charging server, charging information managed by the charging information managing unit 108. In addition, in response to a request from the watcher 30, the charging information transmitting unit 110 may transmit, to the communication terminal 300 of the watcher 30, the charging information about the watcher 30 managed by the charging information managing unit 108. The charging information transmitting unit 110 may transmit the charging information to the communication terminal 300 via the terminal communication unit 104.

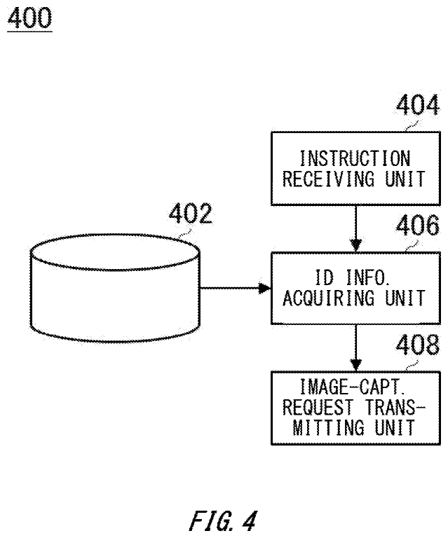

FIG. 4 schematically illustrates an exemplary functional configuration of the communication terminal 400. The communication terminal 400 includes a storage unit 402, an instruction receiving unit 404, an identification information acquiring unit 406, and an image-capturing request transmitting unit 408.

The storage unit 402 stores various types of information. For example, the storage unit 402 stores identification information about the watcher 30. In addition, for example, the storage unit 402 stores an image of the watched person 40. In addition, for example, the storage unit 402 stores information about the gender, age, appearance, clothes, or the like of the watched person 40. In addition, for example, the storage unit 402 stores information indicating the appearance of the communication terminal 400. For example, the storage unit 402 stores an image of the communication terminal 400.

The instruction receiving unit 404 receives an instruction from the management server 100. Upon reception of the instruction by the instruction receiving unit 404, the identification information acquiring unit 406 acquires the identification information about the watcher 30. If the instruction received by the instruction receiving unit 404 includes the identification information about the watcher 30, the identification information acquiring unit 406 may acquire the identification information. The identification information acquiring unit 406 may acquire the identification information about the watcher 30 stored in the storage unit 402.

The image-capturing request transmitting unit 408 transmits an image-capturing request. The image-capturing request transmitting unit 408 may transmit the image-capturing request to surrounding image capturing apparatuses via short-range wireless communication. The image-capturing request transmitting unit 408 may transmit various types of information as information included in the image-capturing request. For example, the image-capturing request transmitting unit 408 transmits, as information included in the image-capturing request, at least any one of an image of the watched person 40, information about the gender, age, appearance, clothes, or the like of the watched person 40, and an image of the communication terminal 400.

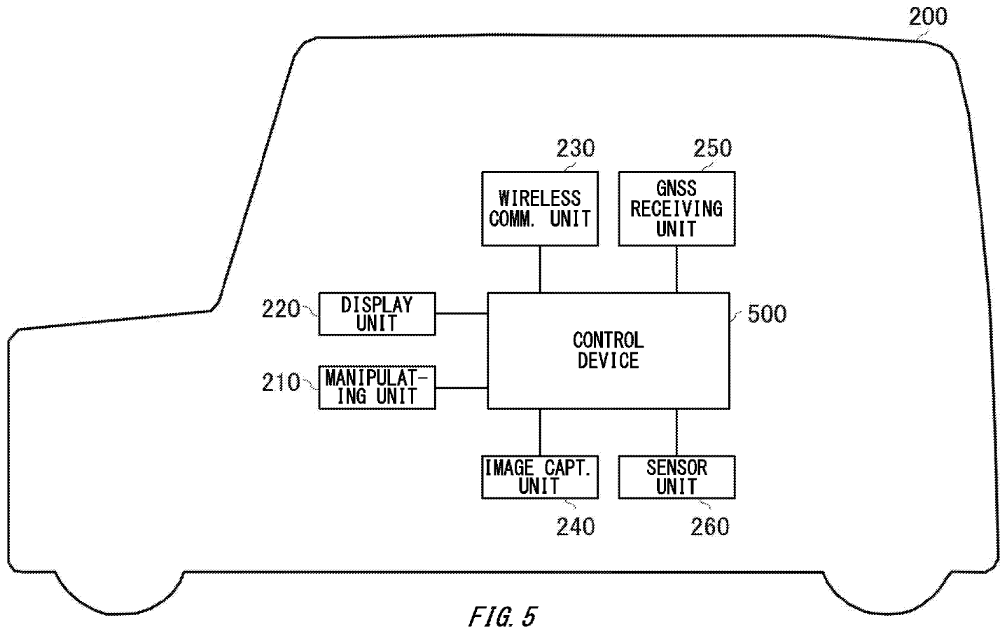

FIG. 5 schematically illustrates an exemplary configuration of the vehicle 200. The vehicle 200 includes a manipulating unit 210, a display unit 220, a wireless communication unit 230, an image capturing unit 240, a GNSS (Global Navigation Satellite System) receiver 250, a sensor unit 260, and a control device 500. At least some of these configurations may be configurations included in a so-called car navigation system.

The manipulating unit 210 undergoes manipulation by a user of the vehicle 200. The manipulating unit 210 may include physical manipulation buttons, and the like. The manipulating unit 210 and display unit 220 may be a touch panel display. The manipulating unit 210 may undergo audio manipulation. The manipulating unit 210 may include a microphone, and a speaker.

The wireless communication unit 230 communicates with the management server 100, communication terminal 300, communication terminal 400, and the like. The wireless communication unit 230 may include a communication unit that communicates with the network 20 via wireless base stations in a mobile phone network. In addition, the wireless communication unit 230 may include a communication unit that communicates with the network 20 via WiFi (registered trademark) access points. In addition, the wireless communication unit 230 may include a communication unit that executes short-range wireless communication.

The image capturing unit 240 includes one or more cameras. The cameras may be a drive recorder. If the image capturing unit 240 includes a plurality of cameras, the plurality of cameras are placed at different positions in the vehicle 200. In addition, the plurality of cameras capture images in different image-capturing directions.

The GNSS receiver 250 receives radio waves emitted from a GNSS satellite. The GNSS receiver 250 may locate the position of the vehicle 200 based on signals received from the GNSS satellite.

The sensor unit 260 includes one or more sensors. For example, the sensor unit 260 includes an acceleration sensor. For example, the sensor unit 260 includes an angular velocity sensor (gyro sensor). For example, the sensor unit 260 includes a geomagnetic sensor. For example, the sensor unit 260 includes a vehicle speed sensor.

The control device 500 controls the manipulating unit 210, display unit 220, wireless communication unit 230, image capturing unit 240, GNSS receiver 250, and sensor unit 260, and executes various types of processing. For example, the control device 500 executes a navigation process. The control device 500 may execute a navigation process similar to a navigation process executed by known car navigation systems.

For example, the control device 500 locates the current position of the vehicle 200 based on output from the GNSS receiver 250, and sensor unit 260, reads out map data corresponding to the current position, and makes the display unit 220 display the map data. In addition, a destination is input to the control device 500 via the manipulating unit 210, and the control device 500 identifies recommended routes from the current position of the vehicle 200 to the destination, and makes the display unit 220 display the recommended routes. If the control device 500 received an indication of selection of a route, the control device 500 gives directions about a course along which the vehicle 200 should travel, via the display unit 220 and a speaker according to the selected route.

If the control device 500 according to the present embodiment received an image-capturing request transmitted by the communication terminal 400, the control device 500 executes a process of transmitting a captured image captured by the image capturing unit 240 to the management server 100 in response to the image-capturing request.

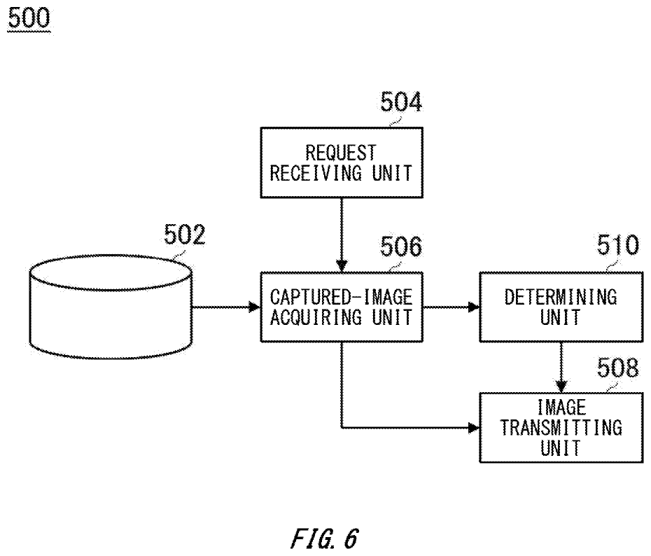

FIG. 6 schematically illustrates an exemplary functional configuration of the control device 500. The control device 500 includes a storage unit 502, a request receiving unit 504, a captured-image acquiring unit 506, an image transmitting unit 508, and a determining unit 510.

The storage unit 502 stores various types of information. The storage unit 502 may store captured images captured by the image capturing unit 240.

The request receiving unit 504 receives an image-capturing request. For example, the request receiving unit 504 receives an image-capturing request that is transmitted by the communication terminal 400, requests to capture an image of the watched person 40, and includes the identification information about the watcher 30.

In response to the image-capturing request received by the request receiving unit 504, the captured-image acquiring unit 506 acquires a captured image of the watched person 40 from the storage unit 502. If the image capturing unit 240 is capturing images continuously, the captured-image acquiring unit 506 acquires a captured image obtained after the request receiving unit 504 received the image-capturing request. In addition, if the image capturing unit 240 is not capturing images continuously, the captured-image acquiring unit 506 may instruct the image capturing unit 240 to start image-capturing, and acquire a captured image captured after the instruction.

If the vehicle 200 includes a plurality of image capturing units 240, the captured-image acquiring unit 506 may acquire a captured image captured by an image capturing unit 240 capturing images in the direction of arrival of the image-capturing request. In addition, if the image-capturing direction of an image capturing unit 240 can be adjusted, the captured-image acquiring unit 506 may adjust the image-capturing direction of the image capturing unit 240 such that it matches the direction of arrival of the image-capturing request.

The image transmitting unit 508 transmits, to the management server 100, a captured image acquired by the captured-image acquiring unit 506, and the identification information about the watcher 30 included in the image-capturing request received by the request receiving unit 504. The image transmitting unit 508 may be an exemplary first image transmitting unit.

The determining unit 510 determines whether or not the captured image acquired by the captured-image acquiring unit 506 includes an image of the watched person 40. The determining unit 510 may use an image of the watched person 40 included in the image-capturing request to determine whether or not the captured image includes an image of the watched person 40. In addition, the determining unit 510 may use information about the gender, age, appearance, clothes, or the like of the watched person 40 included in the image-capturing request to determine whether or not the captured image includes an image of the watched person 40. The image transmitting unit 508 may transmit, to the management server 100, only a captured image determined by the determining unit 510 as including an image of the watched person 40.

The determining unit 510 may determine whether or not the captured image acquired by the captured-image acquiring unit 506 includes an image of the communication terminal 400 of the watched person 40. The determining unit 510 may use an image of the communication terminal 400 included in the image-capturing request to determine whether or not the captured image includes an image of the communication terminal 400. Provided that the captured image includes an image of the communication terminal 400 of the watched person 40, the image transmitting unit 508 may transmit the captured image to the management server 100 even if the captured image does not include an image of the watched person 40. Thereby, it is possible to let the watcher 30 know that the watched person 40 might not be carrying the communication terminal 400.

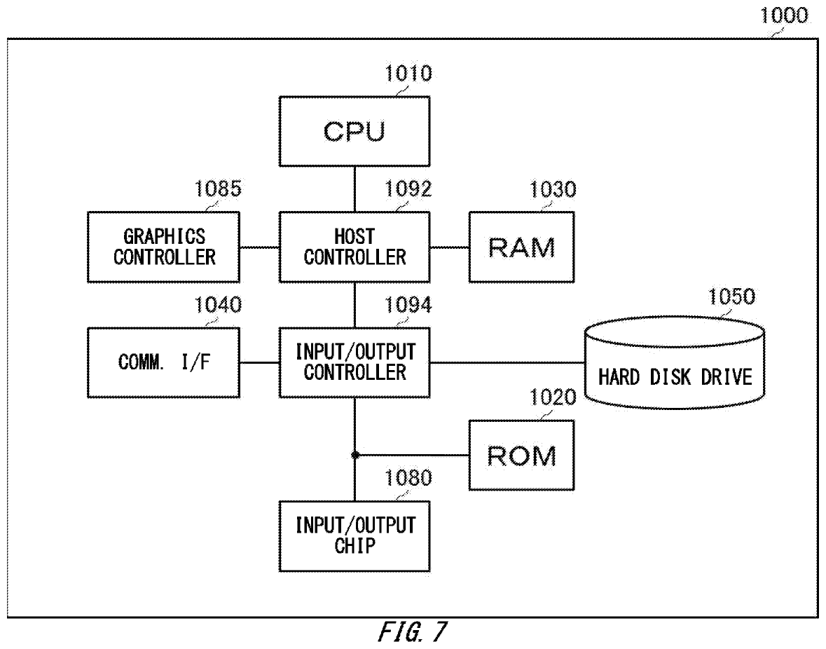

FIG. 7 schematically illustrates an exemplary computer 1000 to function as the management server 100 or control device 500. The computer 1000 according to the present embodiment includes: a CPU peripheral unit having a CPU 1010, a RAM 1030, and a graphics controller 1085 that are interconnected by a host controller 1092; and an input/output unit having a ROM 1020, a communication I/F 1040, a hard disk drive 1050, and an input/output chip 1080 that are connected to the host controller 1092 by an input/output controller 1094.

The CPU 1010 performs operations based on programs stored in the ROM 1020 and RAM 1030, and performs control of a unit(s). The graphics controller 1085 acquires image data generated by the CPU 1010 or the like on a frame buffer provided in the RAM 1030, and makes a display display the image data. Instead, the graphics controller 1085 may include therein a frame buffer to store image data generated by the CPU 1010 or the like.

The communication I/F 1040 communicates with another device via a network. In addition, the communication I/F 1040 functions as hardware to perform communication. The hard disk drive 1050 stores programs and data to be used by the CPU 1010.

The ROM 1020 stores a boot-program to be executed by the computer 1000 at the time of activation, and programs or the like that depend on hardware of the computer 1000. The input/output chip 1080 connects various types of input/output devices to the input/output controller 1094 via, for example, a parallel port, a serial port, a keyboard port, a mouse port, and the like.

Programs to be provided to the hard disk drive 1050 via the RAM 1030 are provided by a user as programs stored in a recording medium such as an IC card. The programs are read out from the recording medium, installed in the hard disk drive 1050 via the RAM 1030, and executed at the CPU 1010.

The programs that are installed in the computer 1000, and make the computer 1000 function as the management server 100 or control device 500 may act on the CPU 1010 or the like, and may each make the computer 1000 function as a unit(s) of the management server 100 or control device 500. Information processing described in these programs are read in by the computer 1000 to thereby function as the storage unit 102, terminal communication unit 104, image capturing apparatus communication unit 106, charging information managing unit 108, and charging information transmitting unit 110, which are specific means attained by cooperation between software and various types of hardware resources mentioned above. In addition, information processing described in these programs are read in by the computer 1000 to thereby function as the storage unit 502, request receiving unit 504, captured-image acquiring unit 506, image transmitting unit 508, and determining unit 510, which are specific means attained by cooperation between software and various types of hardware resources mentioned above. Then, with these specific means, operations on or processing of information corresponding to an intended use of the computer 1000 in the present embodiment are realized to thereby construct the unique management server 100 or control device 500 corresponding to the intended use.

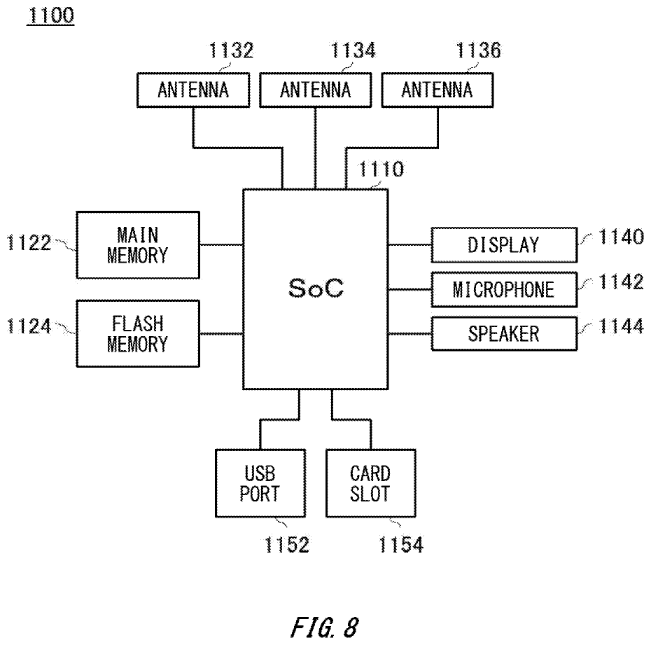

FIG. 8 illustrates an exemplary hardware configuration of a computer 1100 to function as the communication terminal 400. The computer 1100 according to the present embodiment includes an SoC 1110, a main memory 1122, a flash memory 1124, an antenna 1132, an antenna 1134, an antenna 1136, a display 1140, a microphone 1142, a speaker 1144, a USB port 1152, and a card slot 1154.

The SoC 1110 performs operations based on programs stored in the main memory 1122 and flash memory 1124, and performs control of a unit(s). The antenna 1132 is a so-called cellular antenna. The antenna 1134 is a so-called WiFi antenna. The antenna 1136 is a so-called short-range wireless communication antenna such as a Bluetooth antenna. The SoC 1110 may use the antenna 1132, antenna 1134, and antenna 1136 to realize various types of communication functions. The SoC 1110 may use the antenna 1132, antenna 1134, or antenna 1136 to receive a program to be used by the SoC 1110, and store the program in the flash memory 1124.

The SoC 1110 may use the display 1140 to realize various types of display functions. The SoC 1110 may use the microphone 1142 to realize various types of audio input functions. The SoC 1110 may use the speaker 1144 to realize various types of audio output functions.

The USB port 1152 realizes USB connection. The card slot 1154 realizes connection with various types of cards such as SD cards. The SoC 1110 may receive a program to be used by the SoC 1110 from equipment or a memory connected to the USB port 1152, and a card connected to the card slot 1154, and store the program in the flash memory 1124.

The programs that are installed in the computer 1100, and make the computer 1100 function as the communication terminal 400 may act on the SoC 1110 or the like, and may each make the computer 1100 function as a unit(s) of the communication terminal 400. Information processing described in these programs are read in by the computer 1100 to thereby function as the storage unit 402, instruction receiving unit 404, identification information acquiring unit 406, and image-capturing request transmitting unit 408, which are specific means attained by cooperation between software and various types of hardware resources mentioned above. Then, with these specific means, operations on or processing of information corresponding to an intended use of the computer 1100 in the present embodiment are realized to thereby construct the unique communication terminal 400 corresponding to the intended use.

Although in the embodiment explained above, examples of a captured-image viewer and an image-captured subject are the watcher 30 and the watched person 40, they are not limited thereto. As long as the image-captured subject is an image-captured target, and the captured-image viewer is someone to view a captured image of the image-captured subject, they may have any relationship. For example, the captured-image viewer may be a monitor, and the image-captured subject may be someone who is monitored, or they may have another relationship.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: system; 20: network; 30: watcher; 40: watched person; 100: management server; 102: storage unit; 104: terminal communication unit; 106: image capturing apparatus communication unit; 108: charging information managing unit; 110: charging information transmitting unit; 200: vehicle; 210: manipulating unit; 220: display unit; 230: wireless communication unit; 240: image capturing unit; 250: GNSS receiver; 260: sensor unit; 300: communication terminal; 400: communication terminal; 402: storage unit; 404: instruction receiving unit; 406: identification information acquiring unit; 408: image-capturing request transmitting unit; 500: control device; 502: storage unit; 504: request receiving unit; 506: captured-image acquiring unit; 508: image transmitting unit; 510: determining unit; 1000: computer; 1010: CPU; 1020: ROM; 1030: RAM; 1040: communication I/F; 1050: hard disk drive; 1080: input/output chip; 1085: graphics controller; 1092: host controller; 1094: input/output controller; 1100: computer; 1110: SoC; 1122: main memory; 1124: flash memory; 1132: antenna; 1134: antenna; 1136: antenna; 1140: display; 1142: microphone; 1144: speaker; 1152: USB port; 1154: card slot

What is claimed is:

1. A system comprising:
a management server that manages an image; and
an image capturing apparatus, wherein
the image capturing apparatus has:
an image capturing unit;
a request receiving unit that receives an image-capturing request to capture an image of an image-captured subject from a communication terminal of the image-captured subject, the image-capturing request including identification information about a captured-image viewer;
a captured-image acquiring unit that, upon reception of the image-capturing request, acquires a captured image captured by the image capturing unit; and
a first image transmitting unit that transmits the captured image and the identification information about the captured-image viewer to the management server, and
the management server has a second image transmitting unit that transmits, to a communication terminal of the captured-image viewer, the captured image received from the image capturing apparatus.

2. The system according to claim 1, comprising a charging information managing unit that manages charging information about a communication cost incurred from transmission of the captured image from the image capturing apparatus to the management server, based on the identification information about the captured-image viewer received from the image capturing apparatus.

3. The system according to claim 1, wherein, upon reception of the image-capturing request, the captured-image acquiring unit acquires a captured image of the image-captured subject captured by the image capturing unit.

4. The system according to claim 1, wherein the image capturing apparatus is a vehicle having an image capturing unit.

5. The system according to claim 1, wherein the image capturing apparatus is a monitor camera.

6. The system according to claim 1, wherein
the image capturing apparatus has a determining unit that determines whether or not the captured image acquired by the captured-image acquiring unit includes an image of the image-captured subject, and
the first image transmitting unit transmits, to the management server, the captured image determined by the determining unit as including an image of the image-captured subject.

7. The system according to claim 6, wherein
the request receiving unit receives the image-capturing request including an image of the image-captured subject, and
the determining unit uses the image of the image-captured subject to determine whether or not the captured image acquired by the captured-image acquiring unit includes an image of the image-captured subject.

8. The system according to claim 6, wherein
the request receiving unit receives the image-capturing request including information about the image-captured subject, the information including at least any one of a gender, age, appearance, and clothes of the image-captured subject, and
the determining unit uses the information about the image-captured subject to determine whether or not the captured image acquired by the captured-image acquiring unit includes an image of the image-captured subject.

9. The system according to claim 6, wherein
the determining unit determines whether or not the captured image includes an image of the communication terminal of the image-captured subject, and
provided that the captured image includes an image of the communication terminal of the image-captured subject, the image transmitting unit transmits the captured image to the management server even if the captured image does not include an image of the image-captured subject.

10. The system according to claim 9, wherein
the request receiving unit receives the image-capturing request including an image of the communication terminal of the image-captured subject, and
the determining unit uses the image of the communication terminal of the image-captured subject to determine whether or not the captured image includes an image of the communication terminal of the image-captured subject.

11. An image capturing apparatus comprising:
an image capturing unit;
a request receiving unit that receives an image-capturing request to capture an image of an image-captured subject from a communication terminal of the image-captured subject, the image-capturing request including identification information about a captured-image viewer;
a captured-image acquiring unit that, upon reception of the image-capturing request, acquires a captured image captured by the image capturing unit; and
an image transmitting unit that transmits the captured image and the identification information about the captured-image viewer to a management server that manages a captured image.

12. The image capturing apparatus according to claim 11, wherein, upon reception of the image-capturing request, the captured-image acquiring unit acquires a captured image of the image-captured subject captured by the image capturing unit.

13. The image capturing apparatus according to claim 11, wherein the image capturing apparatus is a vehicle having an image capturing unit.

14. The image capturing apparatus according to claim 11, wherein the image capturing apparatus is a monitor camera.

15. The image capturing apparatus according to claim 11, comprising a determining unit that determines whether or not the captured image acquired by the captured-image acquiring unit includes an image of the image-captured subject, wherein
the image transmitting unit transmits, to the management server, the captured image determined by the determining unit as including an image of the image-captured subject.

16. The image capturing apparatus according to claim 15, wherein
the determining unit determines whether or not the captured image includes an image of the communication terminal of the image-captured subject, and
provided that the captured image includes an image of the communication terminal of the image-captured subject, the image transmitting unit transmits the captured image to the management server even if the captured image does not include an image of the image-captured subject.

17. A non-transitory computer-readable storage medium having stored thereon a program for causing a computer to function as the image capturing apparatus according to claim 11.

18. A communication terminal of an image-captured subject, the communication terminal comprising:
an identification information acquiring unit that acquires identification information about a captured-image viewer; and
an image-capturing request transmitting unit that transmits, to an image capturing apparatus, an image-capturing request to capture an image of the image-captured subject, the image-capturing request including the identification information about the captured-image viewer.

19. A non-transitory computer-readable storage medium having stored thereon a program for causing a computer to function as the communication terminal according to claim 18.
